(19) United States
(12) Patent Application Publication
(10) Pub. No.: US 2026/0319797 A1
(43) Pub. Date: Oct. 15, 2026

(54) REGION PREFETCH INSTRUCTION

(71) Applicant: QUALCOMM Incorporated, San Diego, CA (US)

(72) Inventor: Suryanarayana Murthy DURBHAKULA, Hyderabad (IN)

(21) Appl. No.: 19/178,667

(22) Filed: Apr. 14, 2025

(51) Int. Cl. G06F 9/30; G06F 9/38; G06F 12/0875

(52) U.S. Cl. CPC G06F 9/30047; G06F 9/3812; G06F 12/0875; G06F 2212/452

(57) ABSTRACT

This disclosure provides systems, devices, apparatus, and methods, including computer programs encoded on storage media, for region prefetch instructions. A graphics processor may obtain a demand access request indicative of an access of a memory address of a system memory. The graphics processor may determine a prefetch instruction that includes the memory address and a number of cache lines, subsequent to the memory address, indicative of a data region of the system memory. The graphics processor may execute, for a cache, the prefetch instruction.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing may utilize prefetch instructions to obtain data in a local memory such as a cache, from a system memory, for future execution to reduce cache misses and improve latency, but may not address issues with cache sizes, with limited prefetches of cache lines, or with prefetch efficiency for conditional branches in code. There is a need for improved prefetch instruction techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain a demand access request indicative of an access of a memory address of a system memory; determine a prefetch instruction that includes the memory address and a number of cache lines, subsequent to the memory address, indicative of a data region of the system memory; and execute, for a cache, the prefetch instruction.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example of a prefetch instruction for a number of bytes in accordance with one or more techniques of this disclosure.

FIG. 5 illustrates examples of region prefetch instructions for numbers of cache lines in accordance with one or more techniques of this disclosure.

FIG. 6 illustrates examples of region prefetch instructions for numbers of cache lines in accordance with one or more techniques of this disclosure.

FIG. 7 illustrates examples of region prefetch instructions for numbers of cache lines in accordance with one or more techniques of this disclosure.

FIG. 8 is a call flow diagram illustrating example communications between a graphics processor, a CPU, and a cache in accordance with one or more techniques of this disclosure.

FIG. 9 is a flowchart of an example method of graphics processing in accordance with one or more techniques of this disclosure.

FIG. 10 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “prefetch” may refer to a proactive loading of data, graphical content, or other resources, etc., to a cache prior to an instruction in a program or code that calls for fetching the data, graphical content, resources, etc., from a system memory. As used herein, the term “system memory” may refer to memory such as types of random access memory (RAM) that may be external to, and accessible by, a processor or processing unit and used to store data, graphical content, or other resources to facilitate execution of code or program instructions by the processor or processing unit. As used herein, the term “missed address” may refer to a failed attempt to retrieve data associated with an address from a cache. As used herein, the term “region prefetch instruction” may refer to an instruction to prefetch, for a cache and from a system memory, a region of cache lines. As used herein, the term “region of cache lines” may refer to cache lines in a system memory defined by a starting memory address and a number of cache lines. As used herein, the term “demand access requests” may refer to an operation in which a request for data associated with a cache line (e.g., address and data currently in a system memory) may be installed or loaded in a cache for execution of program code. As used herein, the term “cache line” may refer to a fixed-size block of data that is transferred between a cache and system memory. As used herein, the term “inflight indication” may refer to an indication that indicates a request for a cache line from a system memory has been made but the cache line has not yet been returned. As used herein, the term “least recently used” and “LRU” may refer to a policy, an algorithm, and/or associated information by which determinations of cache usage may be made based on a last usage(s). As used herein, the term “bitmap” may refer to a set of bits in which each bit represents a value, state, characteristic, etc., of one of a related number of items, objects, portions of information, and/or the like.

Graphics processors may utilize prefetch instructions to obtain data in a local memory such as a cache, from a system memory, for future execution to reduce cache misses and improve latency. Data cache misses (also: missed addresses or demand misses) are detrimental to performance of memory intensive GPU workloads. Some example prefetch instructions may prefetch at most 128 bytes of data, which may be equivalent to two cache lines at a time. There may be scenarios in which prefetching additional data (e.g., spanning multiple cache lines instead of one or two cache lines) from system memory is beneficial. Further, execution of conditional code branches, e.g., if-else-if-else, etc., may risk prefetching data from the system memory that is not subsequently utilized, yet example prefetch instructions do not include mechanisms that account for such conditional code. Additionally, examples of prefetch instructions do not address selections for different cache levels to reduce pollution of smaller caches.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

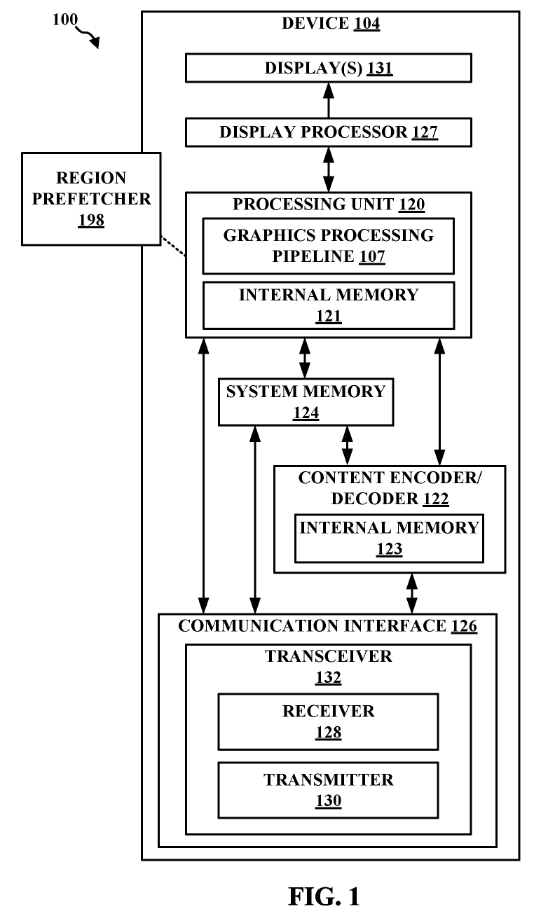

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a region prefetcher 198 configured to obtain a demand access request indicative of an access of a memory address of a system memory; to determine a prefetch instruction that includes the memory address and a number of cache lines, subsequent to the memory address, indicative of a data region of the system memory; and to execute, for a cache, the prefetch instruction. The region prefetcher 198 may also be configured to output an indication of the executed prefetch instruction. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

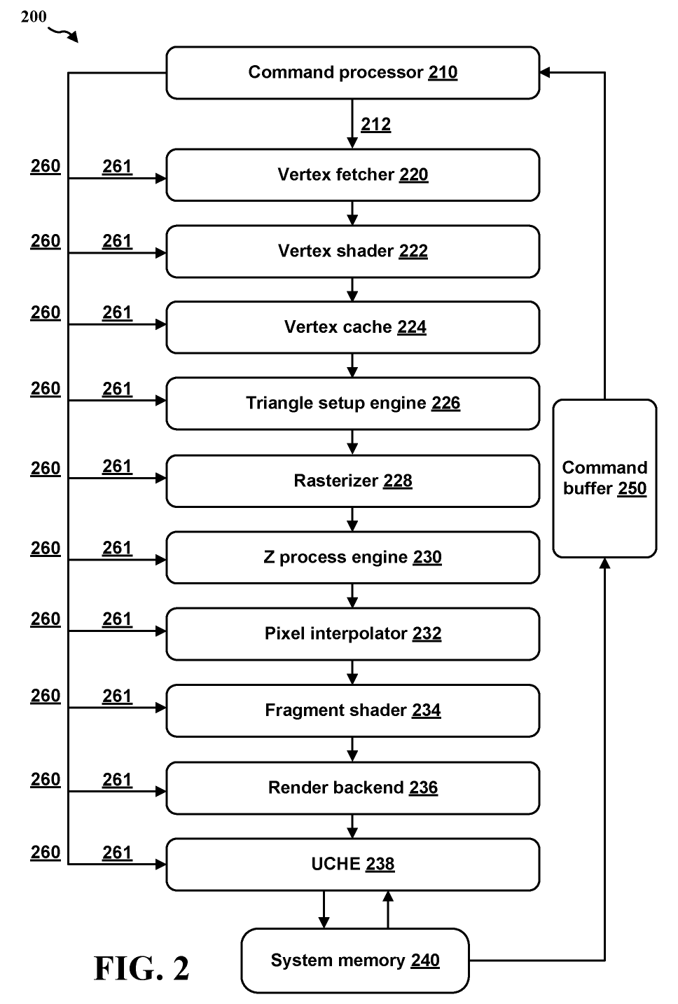

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

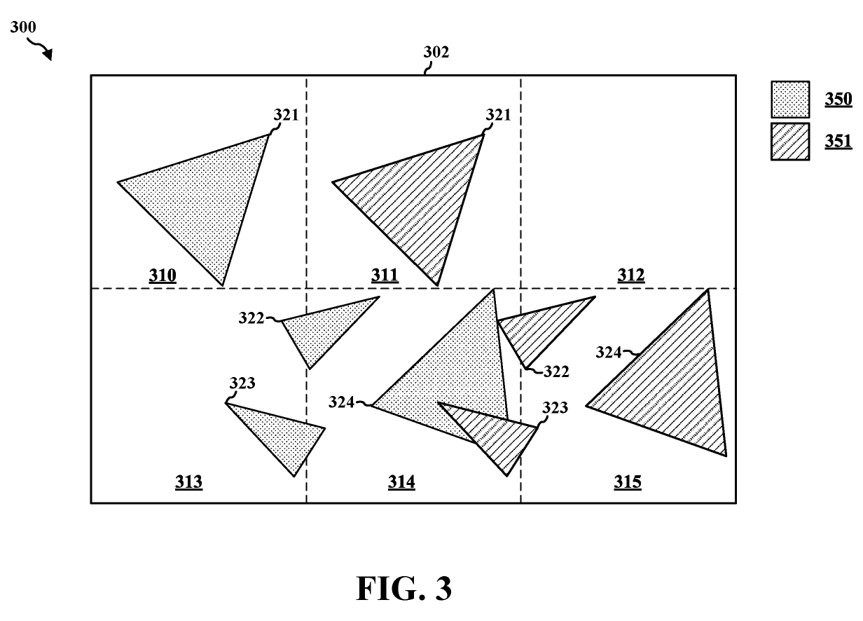

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

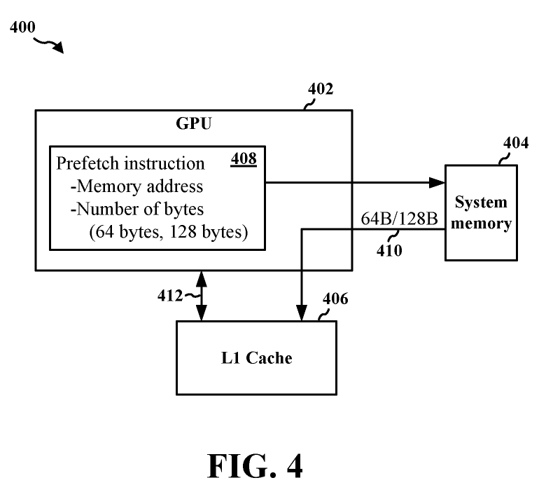

FIG. 4 illustrates a diagram 400 of an example of a prefetch instruction for a number of bytes in accordance with one or more techniques of this disclosure. Diagram 400 shows a GPU 402 that communicates with a system memory 404 and an L1 cache 406.

The GPU 402 may execute a prefetch instruction 408 to fetch a number of bytes 410 (e.g., 64 bytes or 128 bytes), starting at a memory address from the system memory 404 for storing in the L1 cache 406. Stored in the L1 cache 406, the GPU 402 may execute code by more quickly retrieving data 412 from the L1 cache 406 for portions of the number of bytes 410. Yet issues with cache sizes, with limited prefetches of cache lines, or with prefetch efficiency for conditional branches in code are not addressed by such an example of a prefetch instruction for a graphics processor. Aspects herein provide for improved prefetch instructions via region prefetch instructions.

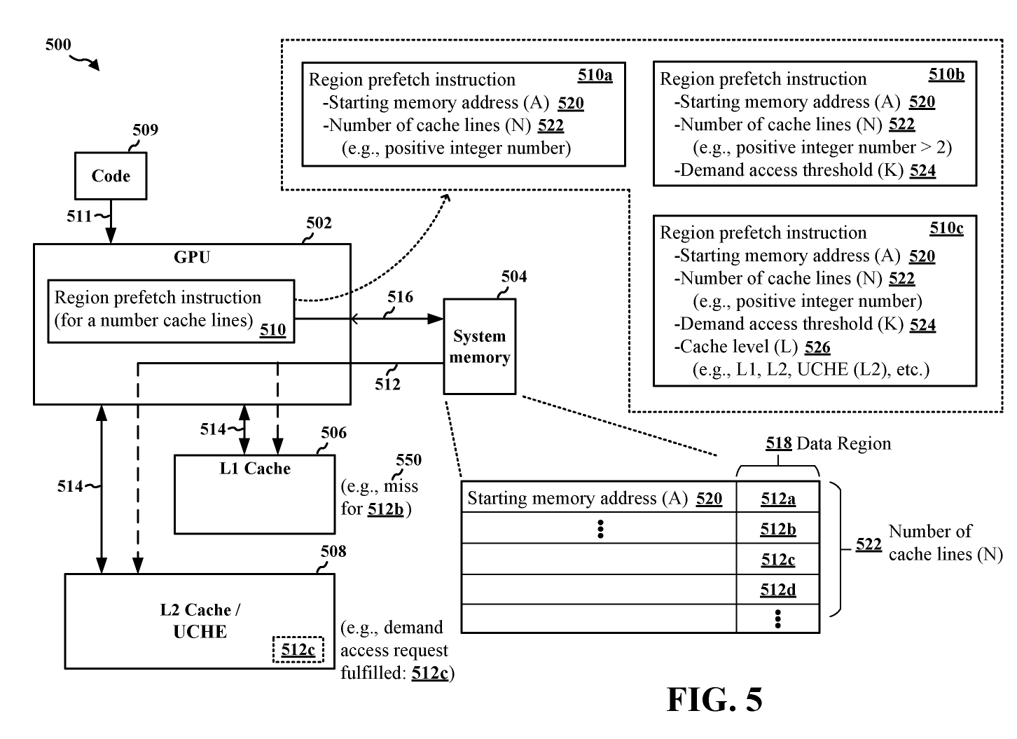

FIG. 5 illustrates a diagram 500 for region prefetch instructions for numbers of cache lines in accordance with one or more techniques of this disclosure. Diagram 500 shows a GPU 502 that communicates with a system memory 504 to prefetch a set of cache lines 512 for a data region 518 using a region prefetch instruction 510 of code 509, and optionally with an L1 cache 506 and/or an L2 cache 508 (which may be a unified cache (UCHE)).

In aspects, the data region 518 may include a number of cache lines 522 (N) as specified in the region prefetch instruction 510, where each cache line corresponds to a memory address starting from a starting memory address 520. As an example, the data region 518 may include a first cache line 512a of the set of cache lines 512 that corresponds to the starting memory address 520, a second cache line 512b of the set of cache lines 512 that corresponds to a second memory address next from the starting memory address 520, a third cache line 512c of the set of cache lines 512 that corresponds to a third memory address next from the second memory address, a fourth cache line 512d of the set of cache lines 512 that corresponds to a fourth memory address next from the third memory address, etc. In an example, the GPU 502 may be configured to request (at 516), from the system memory 504 and as part of executing the region prefetch instruction 510, the set of cache lines 512 (e.g., the first cache line 512a, the second cache line 512b, the third cache line 512c, the fourth cache line 512d, etc.), associated with the data region 518 that corresponds to the starting memory address 520 and the number of cache lines 522. In some aspects, at least one of these cache lines of the set of cache lines 512 includes a missed address 550 associated with a demand access request(s) 511 in the code 509. For example, the GPU 502 may attempt to read data associated with an address from a cache, such as the L1 cache 506 or the L2 cache 508, but if such data associated with the address is not present, the address is missed (e.g., the missed address 550). Accordingly, the GPU 502 may also be configured to receive, from the system memory 504, the set of cache lines 512 associated with the data region 518. In an example, a cache line (e.g., the third cache line 512c) may be outside of the set of cache lines 512 that are requested (at 516) when the cache line already resides in a cache (e.g., as shown, in the L2 cache 508 based on a fulfilled instance of the demand access request(s) 511).

As one example, the GPU 502 may execute the region prefetch instruction 510 to fetch the number of cache lines 522 (e.g., 3, 4, 5, to 64 or more, cache lines), beginning at the starting memory address 520 from the system memory 504 for storing a cache (e.g., in the L1 cache 506 or the L2 cache 508). In such an example, the region prefetch instruction 510 may correspond to a region prefetch instruction 510a that specifies the starting memory address 520 and the number of cache lines 522. Stored in the L1 cache 506 and/or the L2 cache 508, the GPU 502 may execute the code 509 by more quickly retrieving data 514 from the cache for portions of the number of cache lines 522, while caching a larger amount of data as through the data region 518.

As another example, the GPU 502 may execute the region prefetch instruction 510 to fetch the number of cache lines 522, beginning at the starting memory address 520 from the system memory 504 for storing a cache (e.g., in the L1 cache 506 or the L2 cache 508), and the region prefetch instruction 510 may correspond to a region prefetch instruction 510b that specifies the starting memory address 520, the number of cache lines 522, and a demand access threshold 524 (K) (e.g., 2 or more demand accesses to memory addresses for the data region 518). For instance, in addition to the operation for the region prefetch instruction 510a, described above, the demand access threshold 524 specified in the prefetch instruction 510b may be executed when, but not before, a number of the demand access request(s) 511 in the code 509 to memory addresses for the data region 518 reaches a configured number that meets the demand access threshold 524, according to aspects. When the demand access threshold 524 is met, the GPU 502 may be configured to execute the region prefetch instruction 510b to request a set of cache lines 512 for prefetching from the system memory 504 that includes any cache lines for the data region 518 that are not associated with the number of the demand access request(s) 511 counted to meet the demand access threshold 524 (e.g., as some of the set of cache lines 512 for these lines may already be cached based on the respective demand accesses). Stored in the L1 cache 506 and/or the L2 cache 508, the GPU 502 may execute code 509 by more quickly retrieving data 514 from the cache for portions of the number of cache lines 522, while caching a larger amount of data as through the data region 518 and ensuring that a number of the demand access request(s) 511 to the data region 518 that meets the demand access threshold 524 (e.g., to prevent cache pollution for smaller caches when the data region 518 is relatively large).

As another example, the GPU 502 may execute the region prefetch instruction 510 to fetch the number of cache lines 522, beginning at the starting memory address 520 from the system memory 504 for storing a cache (e.g., in the L1 cache 506 or the L2 cache 508), and the region prefetch instruction 510 may correspond to a region prefetch instruction 510c that specifies the starting memory address 520, the number of cache lines 522, a demand access threshold 524 (K), and a cache level 526 (e.g., a cache identifier (ID) that indicates the L1 cache 506 or the L2 cache 508) for caching of the set of cache lines 512. For instance, in addition to the operation for the region prefetch instruction 510a and the region prefetch instruction 510b, described above, the cache level 526 specified in the prefetch instruction 510c may also identify a specific cache in which the set of cache lines 512 is to be stored, according to aspects. Accordingly, aspects provide an option to cache the set of cache lines 512 in the L2 cache 508 to prevent cache pollution for the L1 cache 506 (a smaller cache) when the data region 518 is relatively larger, rather than defaulting to a closest cache, and also provide an option to cache the set of cache lines 512 in the L1 cache 506 (a faster cache) when the data region 518 is relatively smaller.

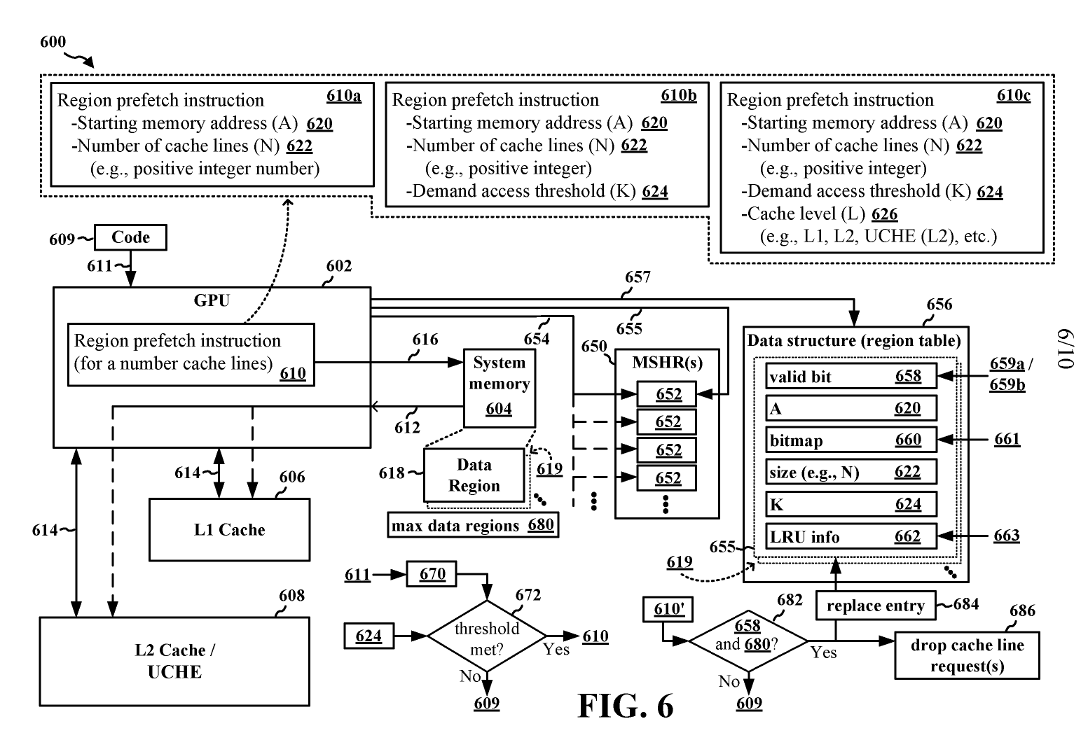

FIG. 6 illustrates a diagram 600 for region prefetch instructions for numbers of cache lines in accordance with one or more techniques of this disclosure. Diagram 600 shows a GPU 602 that communicates with a system memory 604 to prefetch a set of cache lines 612 for a data region 618 using a region prefetch instruction 610 of code 609, and optionally with an L1 cache 606 and/or an L2 cache 608 (which may be a unified cache (UCHE)). Diagram 600 may be an aspect of diagram 500 in FIG. 5.

In aspects, the data region 618 may include a number of cache lines 622 (N) as specified in the region prefetch instruction 610, where each cache line corresponds to a memory address starting from a starting memory address 620. In an example, the GPU 602 may be configured to request (at 616), from the system memory 604 and as part of executing the region prefetch instruction 610, the set of cache lines 612 associated with the data region 618 that corresponds to the starting memory address 620 and the number of cache lines 622. Accordingly, the GPU 602 may be configured to receive, from the system memory 604, the set of cache lines 612 associated with the data region 618. In some aspects, the GPU 602 may have multiple instances of the data region 618 active, and may be configured with a maximum number of data regions 680 allowed to be active at a given time (e.g., 2, 4, 8 (or a different number) of concurrently or at least partially concurrently active instances at a time).

In examples, the GPU 602 may execute the region prefetch instruction 610 to fetch the number of cache lines 622 (e.g., 3, 4, 5, to 64 or more, cache lines), beginning at the starting memory address 620 from the system memory 604 for storing a cache (e.g., in the L1 cache 606 or the L2 cache 608). In aspects, the region prefetch instruction 610 may correspond to a region prefetch instruction 610a that specifies the starting memory address 620 and the number of cache lines 622 to cache in in the L1 cache 606 and/or the L2 cache 608 for the GPU 602 to execute the code 609 by more quickly retrieving data 614 from the cache for portions of the number of cache lines 622, while caching a larger amount of data as through the data region 618. In aspects, the region prefetch instruction 610 may correspond to a region prefetch instruction 610b that specifies the starting memory address 620, the number of cache lines 622, and a demand access threshold 624 (K) (e.g., 2 or more demand accesses to memory addresses for the data region 618). For instance, in addition to the operation for the region prefetch instruction 610a, described above, the demand access threshold 624 specified in the prefetch instruction 610b may be executed when, but not before, a number of the demand access request(s) 611 in the code 609 to memory addresses for the data region 618 reaches a configured number that meets the demand access threshold 624, according to aspects. When the demand access threshold 624 is met, the GPU 602 may be configured to execute the region prefetch instruction 610b to request a set of cache lines 612 for prefetching from the system memory 604 that includes any cache lines for the data region 618 that are not associated with the number of the demand access request(s) 611 counted to meet the demand access threshold 624 (e.g., as some of the set of cache lines 612 for these lines may already be cached based on the respective demand accesses). Stored in the L1 cache 606 and/or the L2 cache 608, the GPU 602 may execute code 609 by more quickly retrieving data 614 from the cache for portions of the number of cache lines 622, while caching a larger amount of data as through the data region 618 and ensuring that a number of the demand access request(s) 611 to the data region 618 that meets the demand access threshold 624 (e.g., to prevent cache pollution for smaller caches when the data region 618 is relatively large). In aspects, the region prefetch instruction 610 may correspond to a region prefetch instruction 610c that specifies the starting memory address 620, the number of cache lines 622, a demand access threshold 624 (K), and a cache level 626 (e.g., a cache ID that indicates the L1 cache 606 or the L2 cache 608) for caching of set of cache lines 612. For instance, in addition to the operation for the region prefetch instruction 610a and the region prefetch instruction 610b, described above, the cache level 626 specified in the prefetch instruction 610c may also identify a specific cache in which the set of cache lines 612 is to be stored, according to aspects. Accordingly, aspects provide an option to cache the set of cache lines 612 in the L2 cache 608 to prevent cache pollution for the L1 cache 606 (a smaller cache) when the data region 618 is relatively larger, rather than defaulting to a closest cache, and also provide an option to cache the set of cache lines 612 in the L1 cache 606 (a faster cache) when the data region 618 is relatively smaller.

In the context of the region prefetch instruction 610a, the region prefetch instruction 610b, and the region prefetch instruction 610c, a miss status handling register(s) (MSHR(s)) such as MSHR(s) 650 may be allocated (at 654) for cache lines requested (at 616) (e.g., missed requests of the demand access request(s) 611 with memory addresses, associated with the data region 618, having data 614 not already cached by fulfilled instances of the demand access request(s) 611). Each allocated register of the MSHR(s) 650 may include an inflight indication 652 that is indicative of a request (at 616) to the system memory 604 for a given cache line. In aspects, utilization of the MSHR(s) 650 may enable subsequent instances of the demand access request(s) 611 of a subsequent region prefetch instruction 610’ to be merged (at 657) with the corresponding register of the MSHR(s) 650 having the same memory address or cache line when a respective instance of the inflight indication 652 is set, e.g., true) in order to increase efficiency and prevent duplicate prefetches.

In the context of the region prefetch instruction 610b and the region prefetch instruction 610c, each including the demand access threshold 624, the GPU 602 may be configured to utilize a request counter 670 to track the number of the demand access request(s) 611 to the data region 618. In aspects, the GPU 602 may be configured to determine (at 672) if the demand access threshold 624 is met based on updates to the request counter 670 associated with the number of the demand access request(s) 611. If the demand access threshold 624 is met, the region prefetch instruction 610b and/or the region prefetch instruction 610c may be executed, or may be continued to be executed, by the GPU 602, according to aspects; if not, the GPU may continue to execute the code 609. Accordingly, a region prefix instruction, based on the demand access threshold 624, may be executed by the GPU 602 for the set of cache lines 612 (which may exclude cache lines for fulfilled instances of the demand access request(s) 611 that are outside of the set of cache lines 612) after a configured number of the demand access request(s) 611 to the data region 618 have successfully occurred.

In the context of the data structure 656, e.g., a region table, a list, etc., the GPU 602 may be configured to allocate (at 657) the data structure 656 in association with a set of data regions 619 that includes the data region 618. In aspects, the data structure 656 may include a number of entries for each active instance of a data region, such as an entry 655 for each data region in the set of data regions 619, for at least one of: a valid bit 658 for the data region 618, a start address of the data region 618 that corresponds to the starting memory address 620, a bitmap 660 that corresponds to cache lines of the data region 618 (e.g., each bit in the bitmap 660 may correspond to a cache line), a size of the data region (e.g., that corresponds to the number of cache lines 622), the demand access threshold 624 for the data region, least recently used (LRU) information 662 (or the like) that corresponds to the data region 618. The LRU information 662 may be updated (at 663) based on usage of data for a given data region of the set of data regions 619 (e.g., for the data 614 for the data region 618). When the demand access request(s) 611 for a cache is determined, the GPU 602 may be configured to check if the demand access request(s) 611 matches with any of the data regions in the set of data regions 619 for which the valid bit 658 is set (at 659a). If so, a bit(s) in the bitmap 660 that corresponds to the cache line(s) for the demand access request(s) 611 may be set (at 661) by the GPU 602. Subsequently, the determination (at 672) may be performed to determine if the demand access threshold 624 has been met for the data region 618, as described above. When all prefetch requests (at 616) are completed the cache lines of the data region 618, the GPU 602 may be configured to reset (at 659b) the valid bit 658 corresponding to the data region 618 in the data structure 656.

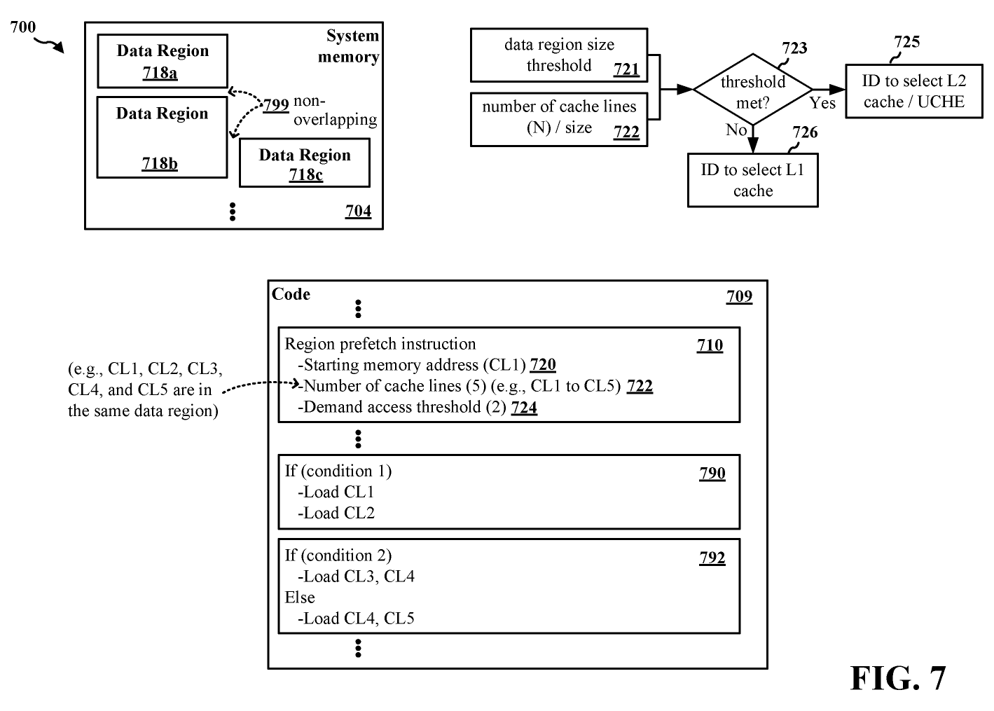

FIG. 7 illustrates a diagram 700 for region prefetch instructions for numbers of cache lines in accordance with one or more techniques of this disclosure. Diagram 700 may be an aspect of diagram 500 in FIG. 5 and/or diagram 600 in FIG. 6.

Diagram 700 shows a system memory 704 with corresponding active data regions of a set of data regions, as described herein: a data region 718a, a data region 718b, and a data region 718c. As illustrated, the data region 718a, the data region 718b, and the data region 718c are non-overlapping 799 with respect to each other.

Diagram 700 also shows a determination (at 723) for whether a data region size threshold 721 is met, as described herein. For example, a region prefetch instruction may include a number of cache lines 722 (N) that corresponds to the size of a data region. A graphic processor may be configured to determine (at 723) if the number of cache lines 722 (N) that corresponds to the size of the data region meets the data region size threshold 721. If so, the graphic processor may indicate (at 725) the ID of an L2 cache and select that L2 cache for installing requested cache lines for the region prefetch instruction based the size of the data region being relatively larger and to avoid pollution of a smaller cache. If not, the graphic processor may indicate (at 726) the ID of an L1 cache and select that L1 cache for installing requested cache lines for the region prefetch instruction based the size of the data region being relatively smaller.

Diagram 700 also shows an example of code 709 for a program which may be utilized by a graphics processor and/or a compiler. As illustrated, the code 709 includes a region prefetch instruction 710 (e.g., as corresponding to the region prefetch instruction 610b in FIG. 6, by way of example and not limitation). The region prefetch instruction 710 specifies the starting memory address 720 for a cache line (CL) CL1, the number of cache lines 722 (e.g., N=5 cache lines: CL1 to CL5), and a demand access threshold 724 (e.g., K=2 demand accesses to memory addresses for the data region starting at CL1 and ending at CL5). In aspects, before issuing prefetches associated with the region prefetch instruction 710, a graphics processor may be configured to wait for demand access requests to K separate cache lines (e.g., K=2 in this example) in the data region. The graphics processor may be configured to issue prefetch requests for the rest (N-K) cache lines. Accordingly, aspects provide for prefetch enhancements in certain scenarios, such as for conditional code. In the illustrated example, the region prefetch instruction 710 in the code 709 may be inserted even before demand access requests (e.g., Load operations, as shown) and conditional operations (e.g., “If(condition1)” as a first conditional 790 and “If(condition2)” as a second conditional 792) using K=2 (e.g., two cache lines) as the demand access threshold 724. Thus, if the program or the code 709 takes the first conditional 790, then the demand access requests for Load CL1 and Load CL2 may satisfy or meet the demand access threshold 724 for the region prefetch instruction 710 to be executed by the graphics processor, by which remaining lines in the data region, which are CL3, CL4, and CL5, may be requested and installed in a cache prior to the program or the code 709 taking the second conditional 792 for operations (i) Load CL3 and Load CL4 or (ii) Load CL4 and Load CL5.

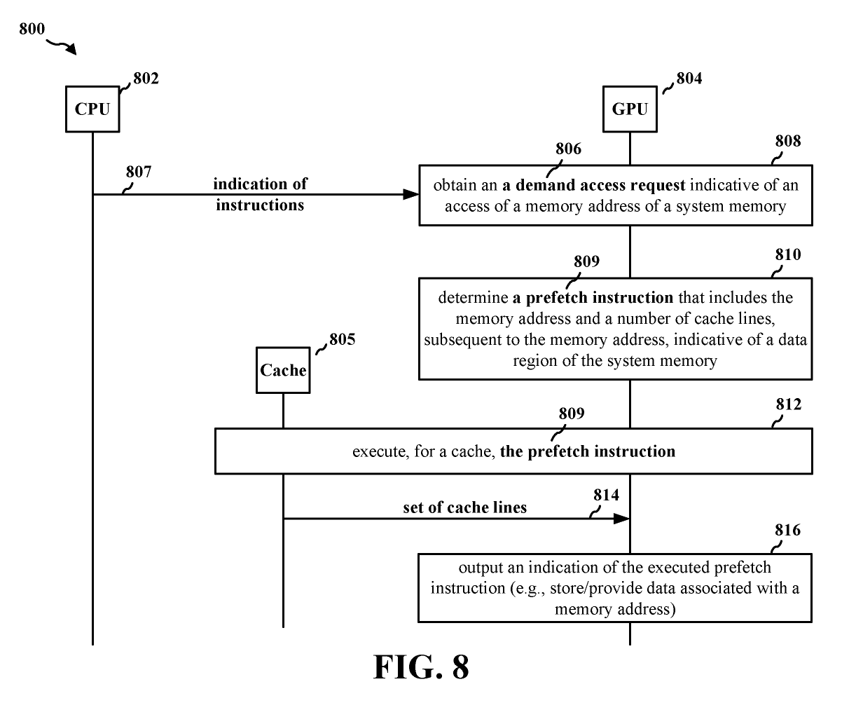

FIG. 8 is a call flow diagram 800 illustrating example communications between a CPU 802, a graphics processor 804, and a cache 805 in accordance with one or more techniques of this disclosure. In aspects, call flow diagram 800 is described for region prefetch instructions. In an example, the graphics processor 804 may be or include the processing unit 120 / the region prefetcher 198. In aspects, the graphics processor 804 comprises a wireless communication device that is configured to perform the call flow diagram 800.

The graphics processor 804 may be configured to obtain (at 808) a demand access request 806 indicative of an access of a memory address of a system memory. In aspects, to obtain (at 808) the demand access request 806, the graphics processor 804 may be configured to receive an indication of instructions 807 (e.g., as commands) from the CPU 802, such as via a graphics driver executed by the CPU 802. The indication of instructions 807 may include or indicate program or application code (e.g., the code 509 in FIG. 5; the code 609 in FIG. 6; the code 709 in FIG. 7), or portions thereof, which include an indication of or the demand access request 806 itself. In some aspects, the program or application code indicated by the indication of instructions 807 may be executed by a shader processor of the graphics processor 804 as part of the obtainment (at 808) of the demand access request 806.

The graphics processor 804 may be configured to determine (at 810) a prefetch instruction 809 that includes the memory address and a number of cache lines, subsequent to the memory address, indicative of a data region of the system memory. In aspects, the prefetch instruction 809 includes a cache ID indicative of an L1 cache or an L2 cache. In aspects, the cache ID may be associated with at least one of a size of the data region or a number of active prefetch instructions. In aspects, the prefetch instruction 809 may further include a demand access threshold (and/or a threshold indication indicative thereof), and in such aspects, to determine (at 810) the prefetch instruction 809, the graphics processor 804 may be configured to determine (at 810) the prefetch instruction 809 based on a number of demand access requests to the data region that meets the demand access threshold.

The graphics processor 804 may be configured to execute (at 812), for the cache 805, the prefetch instruction 809. In aspects, to execute (at 812) the prefetch instruction 809, the graphics processor 804 may be configured to request each of a set of cache lines 814 associated with the data region of the system memory that corresponds to the memory address and the number of cache lines. In aspects, the set of cache lines 814 associated with the data region may include at least one missed address associated with the demand access request 806. To request each of the set of cache lines 814 associated with the data region of the system memory, the graphics processor 804 may be configured to request each of the set of cache lines 814 associated with the data region of the system memory prior to the demand access threshold being met. To execute (at 812) the prefetch instruction 809, the graphics processor 804 may be configured to receive, from the system memory, the set of cache lines 814 associated with the data region of the system memory. In some aspects, at least one cache line that is already present in the cache 805, and is associated with the data region, is outside of the set of cache lines 814 associated with the data region. In aspects, to receive the set of cache lines 814 associated with the data region of the system memory, the graphics processor 804 may be configured to receive the set of cache lines 814 associated with the data region of the system memory subsequent to the demand access threshold being met.

In aspects, to execute (at 812) the prefetch instruction 809, the graphics processor 804 may be configured to allocate a hardware register, for each cache line of the set of cache lines 814, with an inflight indication indicative of a pending request associated with each cache line of the set of cache lines 814. In aspects, to execute (at 812) the prefetch instruction 809, the graphics processor 804 may be configured to merge, based on the inflight indication, at least one subsequent demand request for the set of cache lines 814 together with a respective hardware register. In aspects, to execute (at 812) the prefetch instruction 809, the graphics processor 804 may be configured to allocate a data structure, associated with a set of data regions that includes the data region, where the data structure includes entries, for each data region in the set of data regions, for at least one of: a valid bit for the data region, a start address of the data region that corresponds to the memory address, a bitmap that corresponds to cache lines of the data region, a size of the data region, the demand access threshold for the data region, or LRU information that corresponds to the data region. In some aspects, each data region of the set of data regions is non-overlapping with each other data region of the set of data regions.

In aspects, to execute (at 812) the prefetch instruction 809, the graphics processor 804 may be configured to set a bit in the bitmap based on the memory address indicated by the demand access request 806 being present in the cache 805. In aspects, to execute (at 812) the prefetch instruction 809, the graphics processor 804 may be configured to determine if the demand access threshold is met based on an update to a request counter associated with the number of instances of the demand access request 806. In aspects, to execute (at 812) the prefetch instruction 809, the graphics processor 804 may be configured to allocate a hardware register, for each cache line of the set of cache lines 814, with an inflight indication indicative of a pending request associated with each cache line of the set of cache lines 814. In aspects, to execute (at 812) the prefetch instruction 809, the graphics processor 804 may be configured to reset the valid bit based on reception, from the cache 805, of the set of cache lines 814 associated with the data region of the system memory.

In aspects, the set of data regions may include a maximum configured number of data regions, and the valid bit for each data region, respectively, in the set of data regions may be set. In such aspects, to execute (at 812) the prefetch instruction 809, the graphics processor 804 may be configured to replace, in the data structure and based on the LRU information, an entry associated with the data region with a new entry associated with a new data region that corresponds to a subsequently executed prefetch instruction, and to drop at least one remaining cache line request associated with the prefetch instruction 809.

In aspects, to execute (at 812) the prefetch instruction 809, the graphics processor 804 may be configured to execute the prefetch instruction 809 for the cache 805 based on the cache ID.

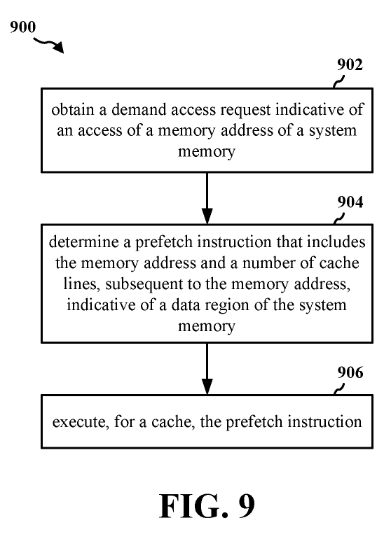

FIG. 9 is a flowchart 900 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-8.

At 904, the apparatus may determine a prefetch instruction that includes the memory address and a number of cache lines, subsequent to the memory address, indicative of a data region of the system memory. For example, referring to FIG. 8, the graphics processor 804 may be configured to determine (at 810) a prefetch instruction 809 (e.g., 510, 510a, 510b, 510c in FIG. 5; 610, 610a, 610b, 610c in FIG. 6; 710 in FIG. 7) that includes the memory address (e.g., 520 in FIG. 5; 620 in FIG. 6; 720 in FIG. 7) and a number of cache lines (e.g., 522 in FIG. 5; 622 in FIG. 6; 722 in FIG. 7), subsequent to the memory address (e.g., 520 in FIG. 5; 620 in FIG. 6; 720 in FIG. 7), indicative of a data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7). In aspects, the prefetch instruction 809 (e.g., 510, 510a, 510b, 510c in FIG. 5; 610, 610a, 610b, 610c in FIG. 6; 710 in FIG. 7) includes a cache ID (e.g., 526 in FIG. 5; 626 in FIG. 6; at 725, at 726 in FIG. 7) indicative of an L1 cache (e.g., 506 in FIG. 5; 606 in FIG. 6) or an L2 cache (e.g., 508 in FIG. 5; 608 in FIG. 6). In aspects, the cache ID (e.g., 526 in FIG. 5; 626 in FIG. 6; at 725, at 726 in FIG. 7) may be associated with at least one of a size (e.g., 522 in FIG. 5; 622 in FIG. 6; 722 in FIG. 7) of the data region (e.g., 518 in FIG. 5; 618 in FIG. 6; 718a, 718b, 718c in FIG. 7) or a number of active prefetch instructions. In aspects, the prefetch instruction 809 (e.g., 510, 510a, 510b, 510c in FIG. 5; 610, 610a, 610b, 610c in FIG. 6; 710 in FIG. 7) may further include a demand access threshold (e.g., 524 in FIG. 5; 624 in FIG. 6; 724 in FIG. 7) (and/or a threshold indication indicative thereof), and in such aspects, to determine (at 810) the prefetch instruction 809 (e.g., 510, 510a, 510b, 510c in FIG. 5; 610, 610a, 610b, 610c in FIG. 6; 710 in FIG. 7), the graphics processor 804 may be configured to determine (at 810) the prefetch instruction 809 (e.g., 510, 510a, 510b, 510c in FIG. 5; 610, 610a, 610b, 610c in FIG. 6; 710 in FIG. 7) based on a number of demand access requests (e.g., 511 in FIG. 5; 611 in FIG. 6; Load CL1, CL2, CL3, CL4, CL5 in FIG. 7) to the data region (e.g., 518 in FIG. 5; 618 in FIG. 6; 718a, 718b, 718c in FIG. 7) that meets the demand access threshold (e.g., 524 in FIG. 5; 624 in FIG. 6; 724 in FIG. 7). In an example, 904 may be performed by the region prefetcher 198.

At 906, the apparatus may execute, for a cache, the prefetch instruction. For example, referring to FIG. 8, the graphics processor 804 may be configured to execute (at 812), for the cache 805 (e.g., 506, 508 in FIG. 5; 606, 608 in FIG. 6), the prefetch instruction 809 (e.g., 510, 510a, 510b, 510c in FIG. 5; 610, 610a, 610b, 610c in FIG. 6; 710 in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to request (e.g., at 516 in FIG. 5; at 616 in FIG. 6) each of a set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7) that corresponds to the memory address (e.g., 520 in FIG. 5; 620 in FIG. 6; 720 in FIG. 7) and the number of cache lines (e.g., 522 in FIG. 5; 622 in FIG. 6; 722 in FIG. 7). In aspects, the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) may include at least one missed address (e.g., 550 in FIG. 5) associated with the demand access request 806 (e.g., 511 in FIG. 5; 611 in FIG. 6; Load CL1, CL2, CL3, CL4, CL5 in FIG. 7). To request (e.g., at 516 in FIG. 5; at 616 in FIG. 6) each of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7), the graphics processor 804 may be configured to request (e.g., at 516 in FIG. 5; at 616 in FIG. 6) each of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7) prior to the demand access threshold (e.g., 524 in FIG. 5; 624 in FIG. 6; 724 in FIG. 7) being met. To execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to receive, from the system memory (e.g., 504 in FIG. 5; 604 in FIG. 6; 704 in FIG. 7), the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7). In some aspects, at least one cache line (e.g., 524 in FIG. 5; 624 in FIG. 6; 724 in FIG. 7) that is already present in the cache 805 (e.g., 506, 508 in FIG. 5; 606, 608 in FIG. 6), and is associated with the data region (e.g., 518 in FIG. 5; 618 in FIG. 6; 718a, 718b, 718c in FIG. 7), is outside of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7). In aspects, to receive the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7), the graphics processor 804 may be configured to receive the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7) subsequent to the demand access threshold (e.g., 524 in FIG. 5; 624 in FIG. 6; 724 in FIG. 7) being met. In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to allocate (e.g., at 654 in FIG. 6) a hardware register (e.g., 650 in FIG. 6), for each cache line of the set of cache lines 814 (e.g., 512, 512a, 512b, 512c, 512d in FIG. 5; 612 in FIG. 6), with an inflight indication (e.g., 652 in FIG. 6) indicative of a pending request (e.g., at 516 in FIG. 5; at 616 in FIG. 6) associated with each cache line of the set of cache lines 814 (e.g., 512, 512a, 512b, 512c, 512d in FIG. 5; 612 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to merge (e.g., at 657 in FIG. 6), based on the inflight indication (e.g., 652 in FIG. 6), at least one subsequent demand request for the set of cache lines 814 (e.g., 512, 512a, 512b, 512c, 512d in FIG. 5; 612 in FIG. 6) together with a respective hardware register (e.g., 650 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to allocate (e.g., at 657 in FIG. 6) a data structure (e.g., 656 in FIG. 6), associated with a set of data regions (e.g., 518 in FIG. 5; 618, 619 in FIG. 6; 718a, 718b, 718c in FIG. 7) that includes the data region (e.g., 518 in FIG. 5; 618 in FIG. 6; 718a, 718b, 718c in FIG. 7), where the data structure (e.g., 656 in FIG. 6) includes entries (e.g., 655 in FIG. 6), for each data region in the set of data regions (e.g., 518 in FIG. 5; 618, 619 in FIG. 6; 718a, 718b, 718c in FIG. 7), for at least one of: a valid bit (e.g., 658 in FIG. 6) for the data region (e.g., 518 in FIG. 5; 618 in FIG. 6; 718a, 718b, 718c in FIG. 7), a start address (e.g., 520 in FIG. 5; 620 in FIG. 6; 720 in FIG. 7) of the data region (e.g., 518 in FIG. 5; 618 in FIG. 6; 718a, 718b, 718c in FIG. 7) that corresponds to the memory address (e.g., 520 in FIG. 5; 620 in FIG. 6; 720 in FIG. 7), a bitmap (e.g., 660 in FIG. 6) that corresponds to cache lines (e.g., 524 in FIG. 5; 624 in FIG. 6; 724 in FIG. 7) of the data region (e.g., 518 in FIG. 5; 618 in FIG. 6; 718a, 718b, 718c in FIG. 7), a size (e.g., 522 in FIG. 5; 622 in FIG. 6; 722 in FIG. 7) of the data region (e.g., 518 in FIG. 5; 618 in FIG. 6; 718a, 718b, 718c in FIG. 7), the demand access threshold (e.g., 524 in FIG. 5; 624 in FIG. 6; 724 in FIG. 7) for the data region (e.g., 518 in FIG. 5; 618 in FIG. 6; 718a, 718b, 718c in FIG. 7), or LRU information (e.g., 662 in FIG. 6) that corresponds to the data region (e.g., 518 in FIG. 5; 618 in FIG. 6; 718a, 718b, 718c in FIG. 7). In some aspects, each data region of the set of data regions (e.g., 518 in FIG. 5; 618, 619 in FIG. 6; 718a, 718b, 718c in FIG. 7) is non-overlapping (e.g., at 799 in FIG. 7) with each other data region of the set of data regions (e.g., 518 in FIG. 5; 618, 619 in FIG. 6; 718a, 718b, 718c in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to set (e.g., at 661 in FIG. 6) a bit in the bitmap (e.g., 660 in FIG. 6) based on the memory address (e.g., 520 in FIG. 5; 620 in FIG. 6; 720 in FIG. 7) indicated by the demand access request 806 (e.g., 511 in FIG. 5; 611 in FIG. 6; Load CL1, CL2, CL3, CL4, CL5 in FIG. 7) being present in the cache 805 (e.g., 506, 508 in FIG. 5; 606, 608 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to determine (e.g., at 672 in FIG. 6) if the demand access threshold (e.g., 524 in FIG. 5; 624 in FIG. 6; 724 in FIG. 7) is met based on an update to a request counter (e.g., 670 in FIG. 6) associated with the number of demand access requests (e.g., 511 in FIG. 5; 611 in FIG. 6; Load CL1, CL2, CL3, CL4, CL5 in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to allocate (e.g., at 654 in FIG. 6) a hardware register (e.g., 650 in FIG. 6), for each cache line of the set of cache lines 814 (e.g., 512, 512a, 512b, 512c, 512d in FIG. 5; 612 in FIG. 6), with an inflight indication (e.g., 652 in FIG. 6) indicative of a pending request associated with each cache line of the set of cache lines 814 (e.g., 512, 512a, 512b, 512c, 512d in FIG. 5; 612 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to reset (e.g., at 659b in FIG. 6) the valid bit (e.g., 658 in FIG. 6) based on reception, from the cache 805 (e.g., 506, 508 in FIG. 5; 606, 608 in FIG. 6), of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7). In aspects, the set of data regions (e.g., 518 in FIG. 5; 618, 619 in FIG. 6; 718a, 718b, 718c in FIG. 7) may include a maximum configured number of data regions (e.g., 680 in FIG. 6), and the valid bit (e.g., 658 in FIG. 6) for each data region, respectively, in the set of data regions (e.g., 518 in FIG. 5; 618, 619 in FIG. 6; 718a, 718b, 718c in FIG. 7) may be set (e.g., at 659a in FIG. 6). In such aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to replace (e.g., at 682 and 684 in FIG. 6), in the data structure (e.g., 656 in FIG. 6) and based on the LRU information (e.g., 662 in FIG. 6), an entry (e.g., 655 in FIG. 6) associated with the data region (e.g., 518 in FIG. 5; 618 in FIG. 6; 718a, 718b, 718c in FIG. 7) with a new entry (e.g., 655 in FIG. 6) associated with a new data region (e.g., 518 in FIG. 5; 618 in FIG. 6; 718a, 718b, 718c in FIG. 7) that corresponds to a subsequently executed prefetch instruction (e.g., 610’ in FIG. 6), and to drop (e.g., at 686 in FIG. 6) at least one remaining cache line request associated with the prefetch instruction 809 (e.g., 510, 510a, 510b, 510c in FIG. 5; 610, 610a, 610b, 610c in FIG. 6; 710 in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to execute the prefetch instruction 809 (e.g., 510, 510a, 510b, 510c in FIG. 5; 610, 610a, 610b, 610c in FIG. 6; 710 in FIG. 7) for the cache 805 (e.g., 506, 508 in FIG. 5; 606, 608 in FIG. 6) based on the cache ID (e.g., 526 in FIG. 5; 626 in FIG. 6; at 723, at 725, at 726 in FIG. 7).

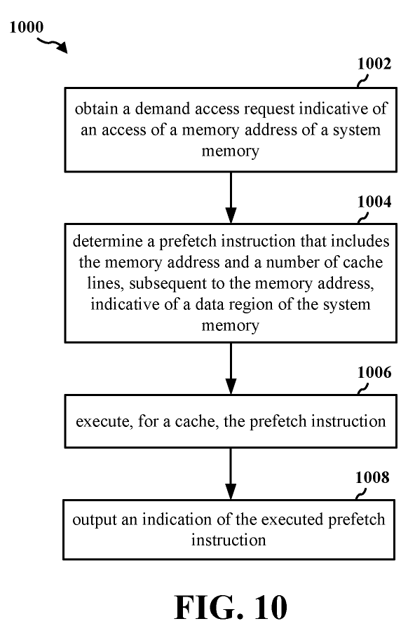

FIG. 10 is a flowchart 1000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-8.

At 1004, the apparatus may determine a prefetch instruction that includes the memory address and a number of cache lines, subsequent to the memory address, indicative of a data region of the system memory. For example, referring to FIG. 8, the graphics processor 804 may be configured to determine (at 810) a prefetch instruction 809 (e.g., 510, 510a, 510b, 510c in FIG. 5; 610, 610a, 610b, 610c in FIG. 6; 710 in FIG. 7) that includes the memory address (e.g., 520 in FIG. 5; 620 in FIG. 6; 720 in FIG. 7) and a number of cache lines (e.g., 522 in FIG. 5; 622 in FIG. 6; 722 in FIG. 7), subsequent to the memory address (e.g., 520 in FIG. 5; 620 in FIG. 6; 720 in FIG. 7), indicative of a data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7). In aspects, the prefetch instruction 809 (e.g., 510, 510a, 510b, 510c in FIG. 5; 610, 610a, 610b, 610c in FIG. 6; 710 in FIG. 7) includes a cache ID (e.g., 526 in FIG. 5; 626 in FIG. 6; at 725, at 726 in FIG. 7) indicative of an L1 cache (e.g., 506 in FIG. 5; 606 in FIG. 6) or an L2 cache (e.g., 508 in FIG. 5; 608 in FIG. 6). In aspects, the cache ID (e.g., 526 in FIG. 5; 626 in FIG. 6; at 725, at 726 in FIG. 7) may be associated with at least one of a size (e.g., 522 in FIG. 5; 622 in FIG. 6; 722 in FIG. 7) of the data region (e.g., 518 in FIG. 5; 618 in FIG. 6; 718a, 718b, 718c in FIG. 7) or a number of active prefetch instructions. In aspects, the prefetch instruction 809 (e.g., 510, 510a, 510b, 510c in FIG. 5; 610, 610a, 610b, 610c in FIG. 6; 710 in FIG. 7) may further include a demand access threshold (e.g., 524 in FIG. 5; 624 in FIG. 6; 724 in FIG. 7) (and/or a threshold indication indicative thereof), and in such aspects, to determine (at 810) the prefetch instruction 809 (e.g., 510, 510a, 510b, 510c in FIG. 5; 610, 610a, 610b, 610c in FIG. 6; 710 in FIG. 7), the graphics processor 804 may be configured to determine (at 810) the prefetch instruction 809 (e.g., 510, 510a, 510b, 510c in FIG. 5; 610, 610a, 610b, 610c in FIG. 6; 710 in FIG. 7) based on a number of demand access requests (e.g., 511 in FIG. 5; 611 in FIG. 6; Load CL1, CL2, CL3, CL4, CL5 in FIG. 7) to the data region (e.g., 518 in FIG. 5; 618 in FIG. 6; 718a, 718b, 718c in FIG. 7) that meets the demand access threshold (e.g., 524 in FIG. 5; 624 in FIG. 6; 724 in FIG. 7). In an example, 1004 may be performed by the region prefetcher 198.

At 1006, the apparatus may execute, for a cache, the prefetch instruction. For example, referring to FIG. 8, the graphics processor 804 may be configured to execute (at 812), for the cache 805 (e.g., 506, 508 in FIG. 5; 606, 608 in FIG. 6), the prefetch instruction 809 (e.g., 510, 510a, 510b, 510c in FIG. 5; 610, 610a, 610b, 610c in FIG. 6; 710 in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to request (e.g., at 516 in FIG. 5; at 616 in FIG. 6) each of a set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7) that corresponds to the memory address (e.g., 520 in FIG. 5; 620 in FIG. 6; 720 in FIG. 7) and the number of cache lines (e.g., 522 in FIG. 5; 622 in FIG. 6; 722 in FIG. 7). In aspects, the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) may include at least one missed address (e.g., 550 in FIG. 5) associated with the demand access request 806 (e.g., 511 in FIG. 5; 611 in FIG. 6; Load CL1, CL2, CL3, CL4, CL5 in FIG. 7). To request (e.g., at 516 in FIG. 5; at 616 in FIG. 6) each of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7), the graphics processor 804 may be configured to request (e.g., at 516 in FIG. 5; at 616 in FIG. 6) each of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7) prior to the demand access threshold (e.g., 524 in FIG. 5; 624 in FIG. 6; 724 in FIG. 7) being met. To execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to receive, from the system memory (e.g., 504 in FIG. 5; 604 in FIG. 6; 704 in FIG. 7), the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7). In some aspects, at least one cache line (e.g., 524 in FIG. 5; 624 in FIG. 6; 724 in FIG. 7) that is already present in the cache 805 (e.g., 506, 508 in FIG. 5; 606, 608 in FIG. 6), and is associated with the data region (e.g., 518 in FIG. 5; 618 in FIG. 6; 718a, 718b, 718c in FIG. 7), is outside of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7). In aspects, to receive the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7), the graphics processor 804 may be configured to receive the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7) subsequent to the demand access threshold (e.g., 524 in FIG. 5; 624 in FIG. 6; 724 in FIG. 7) being met. In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to allocate (e.g., at 654 in FIG. 6) a hardware register (e.g., 650 in FIG. 6), for each cache line of the set of cache lines 814 (e.g., 512, 512a, 512b, 512c, 512d in FIG. 5; 612 in FIG. 6), with an inflight indication (e.g., 652 in FIG. 6) indicative of a pending request (e.g., at 516 in FIG. 5; at 616 in FIG. 6) associated with each cache line of the set of cache lines 814 (e.g., 512, 512a, 512b, 512c, 512d in FIG. 5; 612 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to merge (e.g., at 657 in FIG. 6), based on the inflight indication (e.g., 652 in FIG. 6), at least one subsequent demand request for the set of cache lines 814 (e.g., 512, 512a, 512b, 512c, 512d in FIG. 5; 612 in FIG. 6) together with a respective hardware register (e.g., 650 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to allocate (e.g., at 657 in FIG. 6) a data structure (e.g., 656 in FIG. 6), associated with a set of data regions (e.g., 518 in FIG. 5; 618, 619 in FIG. 6; 718a, 718b, 718c in FIG. 7) that includes the data region (e.g., 518 in FIG. 5; 618 in FIG. 6; 718a, 718b, 718c in FIG. 7), where the data structure (e.g., 656 in FIG. 6) includes entries (e.g., 655 in FIG. 6), for each data region in the set of data regions (e.g., 518 in FIG. 5; 618, 619 in FIG. 6; 718a, 718b, 718c in FIG. 7), for at least one of: a valid bit (e.g., 658 in FIG. 6) for the data region (e.g., 518 in FIG. 5; 618 in FIG. 6; 718a, 718b, 718c in FIG. 7), a start address (e.g., 520 in FIG. 5; 620 in FIG. 6; 720 in FIG. 7) of the data region (e.g., 518 in FIG. 5; 618 in FIG. 6; 718a, 718b, 718c in FIG. 7) that corresponds to the memory address (e.g., 520 in FIG. 5; 620 in FIG. 6; 720 in FIG. 7), a bitmap (e.g., 660 in FIG. 6) that corresponds to cache lines (e.g., 524 in FIG. 5; 624 in FIG. 6; 724 in FIG. 7) of the data region (e.g., 518 in FIG. 5; 618 in FIG. 6; 718a, 718b, 718c in FIG. 7), a size (e.g., 522 in FIG. 5; 622 in FIG. 6; 722 in FIG. 7) of the data region (e.g., 518 in FIG. 5; 618 in FIG. 6; 718a, 718b, 718c in FIG. 7), the demand access threshold (e.g., 524 in FIG. 5; 624 in FIG. 6; 724 in FIG. 7) for the data region (e.g., 518 in FIG. 5; 618 in FIG. 6; 718a, 718b, 718c in FIG. 7), or LRU information (e.g., 662 in FIG. 6) that corresponds to the data region (e.g., 518 in FIG. 5; 618 in FIG. 6; 718a, 718b, 718c in FIG. 7). In some aspects, each data region of the set of data regions (e.g., 518 in FIG. 5; 618, 619 in FIG. 6; 718a, 718b, 718c in FIG. 7) is non-overlapping (e.g., at 799 in FIG. 7) with each other data region of the set of data regions (e.g., 518 in FIG. 5; 618, 619 in FIG. 6; 718a, 718b, 718c in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to set (e.g., at 661 in FIG. 6) a bit in the bitmap (e.g., 660 in FIG. 6) based on the memory address (e.g., 520 in FIG. 5; 620 in FIG. 6; 720 in FIG. 7) indicated by the demand access request 806 (e.g., 511 in FIG. 5; 611 in FIG. 6; Load CL1, CL2, CL3, CL4, CL5 in FIG. 7) being present in the cache 805 (e.g., 506, 508 in FIG. 5; 606, 608 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to determine (e.g., at 672 in FIG. 6) if the demand access threshold (e.g., 524 in FIG. 5; 624 in FIG. 6; 724 in FIG. 7) is met based on an update to a request counter (e.g., 670 in FIG. 6) associated with the number of demand access requests (e.g., 511 in FIG. 5; 611 in FIG. 6; Load CL1, CL2, CL3, CL4, CL5 in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to allocate (e.g., at 654 in FIG. 6) a hardware register (e.g., 650 in FIG. 6), for each cache line of the set of cache lines 814 (e.g., 512, 512a, 512b, 512c, 512d in FIG. 5; 612 in FIG. 6), with an inflight indication (e.g., 652 in FIG. 6) indicative of a pending request associated with each cache line of the set of cache lines 814 (e.g., 512, 512a, 512b, 512c, 512d in FIG. 5; 612 in FIG. 6). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to reset (e.g., at 659b in FIG. 6) the valid bit (e.g., 658 in FIG. 6) based on reception, from the cache 805 (e.g., 506, 508 in FIG. 5; 606, 608 in FIG. 6), of the set of cache lines 814 (e.g., 512, 512a, 512b, 512c, 512d in FIG. 5; 612 in FIG. 6) associated with the data region (e.g., 518 in FIG. 5; 618 in FIG. 6; 718a, 718b, 718c in FIG. 7) of the system memory (e.g., 504 in FIG. 5; 604 in FIG. 6; 704 in FIG. 7). In aspects, the set of data regions (e.g., 518 in FIG. 5; 618, 619 in FIG. 6; 718a, 718b, 718c in FIG. 7) may include a maximum configured number of data regions (e.g., 680 in FIG. 6), and the valid bit (e.g., 658 in FIG. 6) for each data region, respectively, in the set of data regions (e.g., 518 in FIG. 5; 618, 619 in FIG. 6; 718a, 718b, 718c in FIG. 7) may be set (e.g., at 659a in FIG. 6). In such aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to replace (e.g., at 682 and 684 in FIG. 6), in the data structure (e.g., 656 in FIG. 6) and based on the LRU information (e.g., 662 in FIG. 6), an entry (e.g., 655 in FIG. 6) associated with the data region (e.g., 518 in FIG. 5; 618 in FIG. 6; 718a, 718b, 718c in FIG. 7) with a new entry (e.g., 655 in FIG. 6) associated with a new data region (e.g., 518 in FIG. 5; 618 in FIG. 6; 718a, 718b, 718c in FIG. 7) that corresponds to a subsequently executed prefetch instruction (e.g., 610’ in FIG. 6), and to drop (e.g., at 686 in FIG. 6) at least one remaining cache line request associated with the prefetch instruction 809 (e.g., 510, 510a, 510b, 510c in FIG. 5; 610, 610a, 610b, 610c in FIG. 6; 710 in FIG. 7). In aspects, to execute (at 812) the prefetch instruction 809 (e.g., 510, 510a, 510b, 510c in FIG. 5; 610, 610a, 610b, 610c in FIG. 6; 710 in FIG. 7), the graphics processor 804 may be configured to execute the prefetch instruction 809 (e.g., 510, 510a, 510b, 510c in FIG. 5; 610, 610a, 610b, 610c in FIG. 6; 710 in FIG. 7) for the cache 805 (e.g., 506, 508 in FIG. 5; 606, 608 in FIG. 6) based on the cache ID (e.g., 526 in FIG. 5; 626 in FIG. 6; at 723, at 725, at 726 in FIG. 7). In an example, 1006 may be performed by the region prefetcher 198.

At 1008, the apparatus may output an indication of the executed prefetch instruction. For example, referring to FIG. 8, the graphics processor 804 may be configured to output (at 816) an indication of the executed prefetch instruction 809. In aspects, to output (at 816) an indication of the executed the prefetch instruction 809 (e.g., 510, 510a, 510b, 510c in FIG. 5; 610, 610a, 610b, 610c in FIG. 6; 710 in FIG. 7), the graphics processor 804 may be configured to store data associated with the memory address (e.g., 520 in FIG. 5; 620 in FIG. 6; 720 in FIG. 7) for a compiler of an application for execution in association with the graphics processing and/or to provide the data associated with the memory address (e.g., 520 in FIG. 5; 620 in FIG. 6; 720 in FIG. 7) for the execution of the application in association with the graphics processing). In an example, 1008 may be performed by the region prefetcher 198.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: obtaining a demand access request indicative of an access of a memory address of a system memory; determining a prefetch instruction that includes the memory address and a number of cache lines, subsequent to the memory address, indicative of a data region of the system memory; and executing, for a cache, the prefetch instruction.

Aspect 2 is the method of aspect 1, wherein executing the prefetch instruction includes requesting each of a set of cache lines associated with the data region of the system memory that corresponds to the memory address and the number of cache lines, wherein the set of cache lines associated with the data region includes at least one missed address associated with the demand access request; and receiving, from the system memory, the set of cache lines associated with the data region of the system memory.

Aspect 3 is the method of aspect 2, wherein at least one cache line that is already present in the cache, and is associated with the data region, is outside of the set of cache lines associated with the data region.

Aspect 4 is the method of any of aspects 2 and 3, wherein executing the prefetch instruction includes: allocating a hardware register, for each cache line of the set of cache lines, with an inflight indication indicative of a pending request associated with each cache line of the set of cache lines.

Aspect 5 is the method of aspect 4, wherein executing the prefetch instruction includes: merging, based on the inflight indication, at least one subsequent demand request for the set of cache lines together with a respective hardware register.

Aspect 6 is the method of any of aspects aspect 2 to 5, wherein the prefetch instruction further includes a demand access threshold; wherein determining the prefetch instruction includes determining the prefetch instruction in response to a number of demand access requests to the data region meeting the demand access threshold.

Aspect 7 is the method of aspect 6, wherein requesting each of the set of cache lines associated with the data region of the system memory includes requesting each of the set of cache lines associated with the data region of the system memory prior to the demand access threshold being met; and wherein receiving the set of cache lines associated with the data region of the system memory includes receiving the set of cache lines associated with the data region of the system memory subsequent to the demand access threshold being met.

Aspect 8 is the method of aspect 7, wherein executing the prefetch instruction includes: allocating a data structure, associated with a set of data regions that includes the data region, wherein the data structure includes entries, for each data region in the set of data regions, for at least one of: a valid bit for the data region, a start address of the data region that corresponds to the memory address, a bitmap that corresponds to cache lines of the data region, a size of the data region, the demand access threshold for the data region, or least recently used (LRU) information that corresponds to the data region.

Aspect 9 is the method of aspect 8, wherein executing the prefetch instruction includes at least one of: setting a bit in the bitmap based on the memory address indicated by the demand access request being present in the cache; or determining if the demand access threshold is met based on set bits in the bitmap associated with the number of demand access requests.

Aspect 10 is the method of any of aspects 8 and 9, wherein executing the prefetch instruction includes: allocating a hardware register, for each cache line of the set of cache lines, with an inflight indication indicative of a pending request associated with each cache line of the set of cache lines; and resetting the valid bit based on reception, from the cache, of the set of cache lines associated with the data region of the system memory.

Aspect 11 is the method of any of aspects 8 to 10, wherein the set of data regions includes a maximum configured number of data regions, wherein the valid bit for each data region, respectively, in the set of data regions is set; wherein executing the prefetch instruction includes: replacing, in the data structure and based on the LRU information, an entry associated with the data region with a new entry associated with a new data region that corresponds to a subsequently executed prefetch instruction; and dropping at least one remaining cache line request associated with the prefetch instruction.

Aspect 12 is the method of any of aspects 8 to 11, wherein each data region of the set of data regions is non-overlapping with each other data region of the set of data regions.

Aspect 13 is the method of any of aspects 5 to 12, wherein the prefetch instruction includes a cache identifier (ID) indicative of a level 1 (L1) cache or a level 2 (L2) cache.

Aspect 14 is the method of aspect 13, wherein executing the prefetch instruction includes executing the prefetch instruction for the cache based on the cache ID.

Aspect 15 is the method of any of aspects 13 and 14, wherein the cache ID is associated with at least one of a size of the data region or a number of active prefetch instructions.

Aspect 16 is the method of any of aspects 1 to 15, further comprising: outputting an indication of the executed prefetch instruction.

Aspect 17 is the method of aspect 16, wherein outputting the indication of the executed prefetch instruction includes at least one of: storing data associated with the memory address for a compiler of an application for execution in association with the graphics processing; or providing the data associated with the memory address for the execution of the application in association with the graphics processing.

Aspect 18 is an apparatus for graphics processing comprising a processor coupled to a memory and, based on information stored in the memory, the processor is configured to implement a method as in any of aspects 1-17.

Aspect 19 may be combined with aspect 18 and comprises that the apparatus is a wireless communication device.

Aspect 20 is an apparatus for graphics processing comprising means for implementing a method as in any of aspects 1-17.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain a demand access request indicative of an access of a memory address of a system memory;
determine a prefetch instruction that includes the memory address and a number of cache lines, subsequent to the memory address, indicative of a data region of the system memory; and
execute, for a cache, the prefetch instruction.

2. The apparatus of claim 1, wherein to execute the prefetch instruction, the processor is configured to:
request each of a set of cache lines associated with the data region of the system memory that corresponds to the memory address and the number of cache lines, wherein the set of cache lines associated with the data region includes at least one missed address associated with the demand access request; and
receive, from the system memory, the set of cache lines associated with the data region of the system memory.

3. The apparatus of claim 2, wherein at least one cache line that is already present in the cache, and is associated with the data region, is outside of the set of cache lines associated with the data region.

4. The apparatus of claim 2, wherein to execute the prefetch instruction, the processor is configured to:
allocate a hardware register, for each cache line of the set of cache lines, with an inflight indication indicative of a pending request associated with each cache line of the set of cache lines.

5. The apparatus of claim 4, wherein to execute the prefetch instruction, the processor is configured to:
merge, based on the inflight indication, at least one subsequent demand request for the set of cache lines together with a respective hardware register.

6. The apparatus of claim 2, wherein the prefetch instruction further includes a demand access threshold;
wherein to determine the prefetch instruction, the processor is configured to determine the prefetch instruction in response to a number of demand access requests to the data region meeting the demand access threshold.

7. The apparatus of claim 6, wherein to request each of the set of cache lines associated with the data region of the system memory, the processor is configured to request each of the set of cache lines associated with the data region of the system memory prior to the demand access threshold being met; and
wherein to receive the set of cache lines associated with the data region of the system memory, the processor is configured to receive the set of cache lines associated with the data region of the system memory subsequent to the demand access threshold being met.

8. The apparatus of claim 7, wherein to execute the prefetch instruction, the processor is configured to:
allocate a data structure, associated with a set of data regions that includes the data region, wherein the data structure includes entries, for each data region in the set of data regions, for at least one of: a valid bit for the data region, a start address of the data region that corresponds to the memory address, a bitmap that corresponds to cache lines of the data region, a size of the data region, the demand access threshold for the data region, or least recently used (LRU) information that corresponds to the data region.

9. The apparatus of claim 8, wherein to execute the prefetch instruction, the processor is configured to at least one of:
set a bit in the bitmap based on the memory address indicated by the demand access request being present in the cache; or
determine if the demand access threshold is met based on set bits in the bitmap associated with the number of demand access requests.

10. The apparatus of claim 8, wherein to execute the prefetch instruction, the processor is configured to:
allocate a hardware register, for each cache line of the set of cache lines, with an inflight indication indicative of a pending request associated with each cache line of the set of cache lines; and
reset the valid bit based on reception, from the cache, of the set of cache lines associated with the data region of the system memory.

11. The apparatus of claim 8, wherein the set of data regions includes a maximum configured number of data regions, wherein the valid bit for each data region, respectively, in the set of data regions is set;
wherein to execute the prefetch instruction, the processor is configured to:
replace, in the data structure and based on the LRU information, an entry associated with the data region with a new entry associated with a new data region that corresponds to a subsequently executed prefetch instruction; and
drop at least one remaining cache line request associated with the prefetch instruction.

12. The apparatus of claim 8, wherein each data region of the set of data regions is non-overlapping with each other data region of the set of data regions.

13. The apparatus of claim 5, wherein the prefetch instruction includes a cache identifier (ID) indicative of a level 1 (L1) cache or a level 2 (L2) cache.

14. The apparatus of claim 13, wherein to execute the prefetch instruction, the processor is configured to execute the prefetch instruction for the cache based on the cache ID.

15. The apparatus of claim 13, wherein the cache ID is associated with at least one of a size of the data region or a number of active prefetch instructions.

16. The apparatus of claim 1, wherein the processor is further configured to:
output an indication of the executed prefetch instruction.

17. The apparatus of claim 16, wherein to output the indication of the executed prefetch instruction, the processor is configured to at least one of:
store data associated with the memory address for a compiler of an application for execution in association with the graphics processing; or
provide the data associated with the memory address for the execution of the application in association with the graphics processing.

18. The apparatus of claim 1, wherein the apparatus is a wireless communication device.

19. A method of graphics processing, comprising:
obtaining a demand access request indicative of an access of a memory address of a system memory;
determining a prefetch instruction that includes the memory address and a number of cache lines, subsequent to the memory address, indicative of a data region of the system memory; and
executing, for a cache, the prefetch instruction.

20. A computer-readable medium storing computer executable code, the computer executable code, when executed by a processor, causes the processor to:
obtain a demand access request indicative of an access of a memory address of a system memory;
determine a prefetch instruction that includes the memory address and a number of cache lines, subsequent to the memory address, indicative of a data region of the system memory; and
execute, for a cache, the prefetch instruction.
